(19) United States
(12) Patent Application Publication
(10) Pub. No.: US 2007/0019421 A1
(43) Pub. Date: Jan. 25, 2007

(54) Removable, multi-purpose utility light for motor vehicles

(76) Inventors: Christopher A. Kregness, Deephaven, MN (US); Harry W. Webster JR., Deephaven, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/484,430

(22) Filed: Jul. 11, 2006

Related U.S. Application Data
(60) Provisional application No. 60/698,648, filed on Jul. 12, 2005.

(51) Int. Cl. F21S 8/00

(52) U.S. Cl. 362/427

(57) ABSTRACT

Auxiliary lighting for motor vehicles. The lighting system of the invention may be configured so that it both mounts to and draws power from a socket on the vehicle. The lighting systems may use one or more heat management strategies to help dissipate heat generated during operation. A user may easily switch among two or more operational modes. In preferred modes, the user may select among available modes simply by relative rotational motion among housing components. Some aspects of the invention also use a combination of reflecting elements that provide a very favorable pattern of illumination. According to one such embodiment, a primary reflector includes a dichroic surface that reflects some light outward, but allows some light to pass. A secondary reflector is then used to capture and reflect the passing light outward as well.

### CLAIM OF PRIORITY

The present non-provisional patent Application claims priority under 35 USC §119(e) from U.S. Provisional Patent Application having Ser. No. 60/698,648, filed on Jul. 12, 2005, by Christopher Kregness and Harry Waite Webster, Jr., and titled REMOVABLE DUAL PURPOSE REVERSE AND UTILITY LIGHT FOR MOTOR VEHICLES, wherein the entirety of said provisional patent application is incorporated herein by reference.

### FIELD OF THE INVENTION

The present invention relates to auxiliary lighting for vehicles. More specifically, the present invention relates to multi-purpose auxiliary lighting that provides illumination depending upon a state of the vehicle. For example, the lighting can provide illumination when the vehicle is placed into reverse and/or provide utility illumination whenever the vehicle running or parking lights are turned on.

### BACKGROUND OF THE INVENTION

Motor vehicles have both front and reverse lighting systems. Front lighting normally uses relatively high output lights that provide adequate illumination in the forward direction. However, reverse lighting systems tend to generate much lower levels of illumination behind the vehicle. This low level of illumination can make it difficult for a driver to see behind the vehicle at night when backing up. The low level of illumination also is inadequate to provide adequate utility lighting for many activities that may be carried out behind a parked vehicle at night. These include loading and unloading the vehicle, vehicle repair or maintenance, attaching a trailer, and working with other items, e.g., setting up camping gear, unrelated to the vehicle itself.

Clearly, there is a need for auxiliary lighting systems that provide better illumination behind a vehicle at night. Indeed, auxiliary lighting systems for motor vehicles are known and have been described, for example, in U.S. Pat. Nos. 4,106,081; 4,857,807; 6,053,627; 6,097,283; 6,379,028; and 6,409,367.

Conventional auxiliary lighting for motor vehicles may suffer from one or more drawbacks. For instance, some auxiliary lighting systems are relatively cumbersome with many parts to set up, and switches and/or wiring may be exposed to the elements. Some are compact but may have a tendency to poorly manage heat generated during light operation, and yet heat management becomes increasingly important with more compact designs. Others are cumbersome to mount and operate. Some mount directly to a trailer hitch so that they may not be used when a trailer is attached to a vehicle. Some are conveniently multi-function and yet can only be switched between functions from inside the vehicle. Some may tend to generate poor patterns of illumination behind the vehicle, e.g., the illumination may be too narrowly broadcast. Thus, improvements are still needed in one or more areas, either singly or in combination.

### SUMMARY OF THE INVENTION

The present invention provides many strategies for improving auxiliary lighting for motor vehicles, wherein these strategies may be implemented singly or in combination. The lighting system of the invention may be very compact. It is easy to mount and remove from a vehicle. Assembly and disassembly of parts during mounting and removal is not needed. Additionally, rather than mounting to a trailer hitch with external wiring coupling the hitch-mounted item to the electrical system of the vehicle, the lighting system of the invention may be configured so that it both mounts to and draws power from a socket on the vehicle. This easily allows all wiring to be internally housed and protected from the elements. Mounting is very easy. Simply mount and plug the system into the vehicle socket and it is ready for use. Simply pull the system out and it is ready for storage.

Notwithstanding the compactness of some embodiments, the lighting systems may use one or more elegantly simple heat management strategies to help dissipate heat generated during operation. In some modes, using lower wattage light bulbs may minimize this heat output. However, this is not always desirable, as lower wattage bulbs may not produce the desired degree of illumination. Advantageously, the heat management strategies of the present invention allow higher wattage bulbs to be used, if desired, without undue heat build up. As one strategy, at least one reflector has a relatively long neck, or body, extending backward away from the light emitting element. When thermally coupled to the lighting, the long neck functions as a passive heat sink to convey heat away from the lighting. The housing optionally may be vented to further help carry the heat away from the heat sink. Additionally, the light emitting element is encased in an envelope that helps a heat reflecting surface direct heat outward through the lens cover and away from the unit. For extra compactness, the heat reflecting surface and a light reflecting surface may be integrated into the same reflector element.

A user may easily switch among two or more operational modes. For instance, the lighting system may include a reverse/back up mode that provides illumination when a vehicle is placed into reverse gear. Alternatively, the system may include a utility mode that provides illumination when the parking lights of the vehicle are turned on. In preferred modes, the user may select among available modes simply by relative rotational motion among housing components.

The use of a relative rotational motion between housing elements to switch among operation modes provides many advantages. First, modes can be selected right at the light itself without having to enter the vehicle to make a change. The approach also facilitates embodiments that are compact and allows the wiring and switches to be internally housed where they are protected from the elements. Thus, the rotational approach is one design aspect that helps to provide the device with a weather tight seal and longer service life. Additionally, the rotation to switch among modes may be generally perpendicular to the direction in which the lighting system is mounted to and removed from a socket on a vehicle. This minimizes the chance that the lighting system might fall out or otherwise be inadvertently loosened when switching modes. Further, this also minimizes the chance that an impact will accidentally turn on the lighting system.

Some aspects of the invention also use a combination of reflecting elements that provide a very favorable pattern of illumination. According to one such embodiment, a primary reflector includes a dichroic surface that reflects some light outward, but allows some light to pass. A secondary reflector is then used to capture and reflect the passing light outward as well. Using two stages of reflectors helps to provide a broader, more uniform field of illumination behind a vehicle.

In one aspect, the present invention relates to a light assembly for a vehicle, comprising:
a) a housing comprising at least first and second housing elements, wherein the first housing element is rotatable with respect to the second housing element;
b) a light emitting element positioned in the housing, said light emitting element emitting a first light output in accordance with a first mode of operation and a second light output in accordance with a second mode of operation; and
c) a switch incorporated into the light assembly in a manner such that relative rotation of the first and second housing elements allows a user to select a mode of operation from the group including at least the first and second modes of operation.

In one aspect, the present invention relates to a light assembly for a vehicle, comprising:
a) a housing;
b) a light emitting element positioned in the housing; and

wherein the light assembly is both mounted to and electrically coupled to a socket on the vehicle in a manner that allows a user to select a mode of operation from among a group including at least first and second modes of operation, wherein said selecting causes the light emitting element to generate a light output depending upon a state of the vehicle.

In one aspect, the present invention relates to a light assembly for a vehicle, comprising:
a) a light emitting element that is electrically coupled to the vehicle in a manner such that the light emitting element generates a light output in accordance with a mode of operation that depends upon a state of the vehicle; and
b) a dichroic surface positioned in a manner effective to reflect a portion of the light output and is light transmissive with respect to a second portion of the light output.

In one aspect, the present invention relates to a light assembly for a vehicle, comprising:
a) a light emitting element that is electrically coupled to the vehicle in a manner such that the light emitting element generates a light output in accordance with a mode of operation that depends upon a state of the vehicle;
b) a dichroic surface positioned in a manner effective to reflect a portion of the light output and is light transmissive with respect to a second portion of the light output; and
c) a secondary reflecting surface positioned in a manner effective to reflect a portion of the light transmitted through the dichroic surface.

In one aspect, the present invention relates to a light assembly for a vehicle, comprising:
a) a light emitting element that is electrically coupled to the vehicle in a manner such that the light emitting element generates a heat output and further generates a light output in accordance with a mode of operation that depends upon a state of the vehicle; and
b) a reflector comprising a reflecting surface that reflects at least a portion of the light output outward to provide illumination and an elongated neck, wherein the elongated neck is in thermal contact with the light emitting element in a manner such that the elongated neck functions as a heat sink to help dissipate at least a portion of the heat output.

In one aspect, the present invention relates to a light assembly for a vehicle, comprising:
a) a light emitting element that is electrically coupled to the vehicle in a manner such that the light emitting element generates a heat output and further generates a light output in accordance with a mode of operation that depends upon a state of the vehicle; and
b) an encasement having an interior in which the light emitting element is positioned, said encasement comprising
c) a light and heat reflecting surface positioned in a manner effective to reflect at least a portion of the light and heat output and
d) a light transmissive cover through which the light output and the reflected light pass to illuminate an area in the proximity of the light assembly.

In one aspect, the present invention relates to a light assembly for a vehicle, comprising:
a) a light emitting element that is electrically coupled to the vehicle in a manner such that the light emitting element generates a heat output and further generates a light output in accordance with a mode of operation that depends upon a state of the vehicle; and
b) an encasement having an interior in which the light emitting element is positioned, said encasement comprising a light and heat reflecting surface positioned in a manner effective to reflect at least a portion of the light and heat output and a light transmissive cover through which the light output and the reflected light pass to illuminate an area in the proximity of the light assembly.

### BRIEF DESCRIPTION OF THE DRAWINGS

The above mentioned and other advantages of the present invention, and the manner of attaining them, will become more apparent and the invention itself will be better understood by reference to the following description of the embodiments of the invention taken in conjunction with the accompanying drawings, wherein:

FIG. 1 is a perspective view of a light assembly of the present invention;

FIG. 2 is an end view of the light assembly of FIG. 1.

FIG. 3 is a side view of the light assembly of FIG. 1.

FIG. 4 is a side view of the light assembly of FIG. 1.

FIG. 5 is a side view of the light assembly of FIG. 1.

FIG. 6 is a cross-sectional side view of the light assembly of FIG. 1 taken along line A-A of FIG. 5.

FIG. 7 is a cross-sectional side view of the light assembly of FIG. 1 taken along line B-B of FIG. 4.

FIG. 8 is an end view of the main body used in the light assembly of FIG. 1.

FIG. 9 is a perspective view of the main body used in the light assembly of FIG. 1.

FIG. 10 is a side view of the main body shown in FIG. 9.

FIG. 11 is a side view of the main body shown in FIG. 9.

FIG. 12 is a side view of the main body shown in FIG. 9.

FIG. 13 is a side view of the main body shown in FIG. 9.

FIG. 14 is a side view of the main body shown in FIG. 9.

FIG. 15 is a cross-sectional side view of the switch body shown in FIG. 16 taken along line B-B.

FIG. 16 is an end view of the switch body used in the light assembly of FIG. 1.

FIG. 17 FIG. 15 is a close-up, cross-sectional side view of a portion of the switch body shown in FIG. 16 taken along line B-B.

FIG. 18 is a cross-sectional side view of the switch body of FIG. 16 taken along line A-A.

FIG. 19 is a perspective view of the switch body of FIG. 16.

FIG. 20 is a side view of the switch body of FIG. 16.

FIG. 21 is a perspective view of the cover used in the light assembly of FIG. 2.

FIG. 22 is a close-up, cross-sectional side view of a portion of the cover shown in FIG. 21 taken along line A-A of FIG. 25.

FIG. 23 is a side cross-sectional view of the cover shown in FIG. 21 taken along line A-A of FIG. 25.

FIG. 24 is a side view of the cover shown in FIG. 21.

FIG. 25 is a top view of the cover shown in FIG. 21.

FIG. 26 is a side view of the reflector used in the light assembly of FIG. 2.

FIG. 27 is a perspective view of the reflector shown in FIG. 26.

FIG. 28 is a cross-sectional side view of the reflector shown in FIG. 26, taken along line A-A of FIG. 29.

FIG. 29 is a top view of the reflector shown in FIG. 26.

FIG. 30 shows a preferred wiring system used in the light assembly of FIG. 2.

FIG. 31 is a cross-sectional side view of an alternative embodiment of a light assembly of the present invention.

FIG. 32 is another cross-sectional side view of the light assembly shown in FIG. 31.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

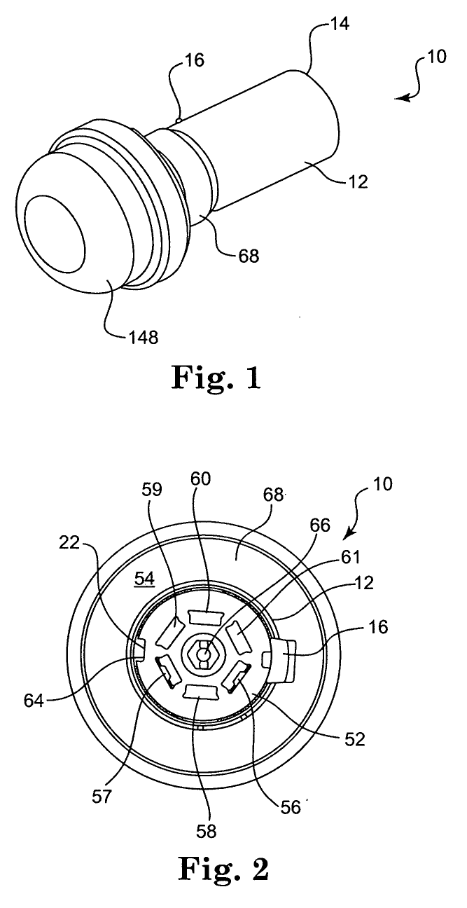

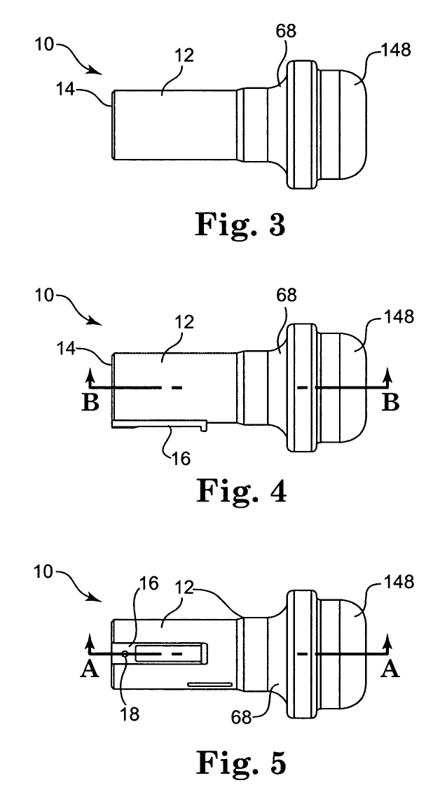

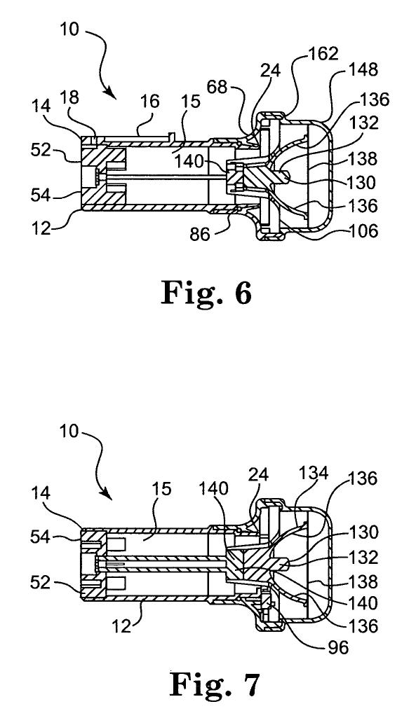

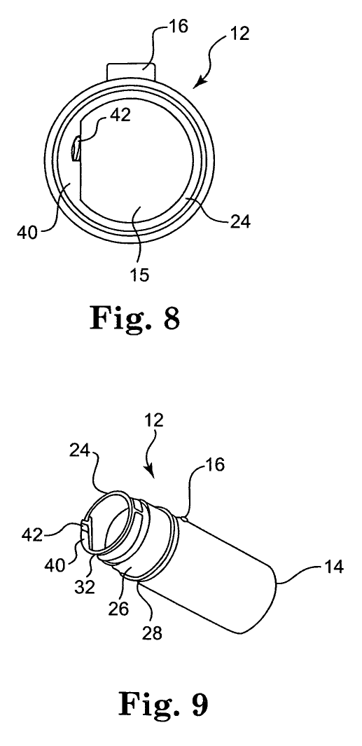

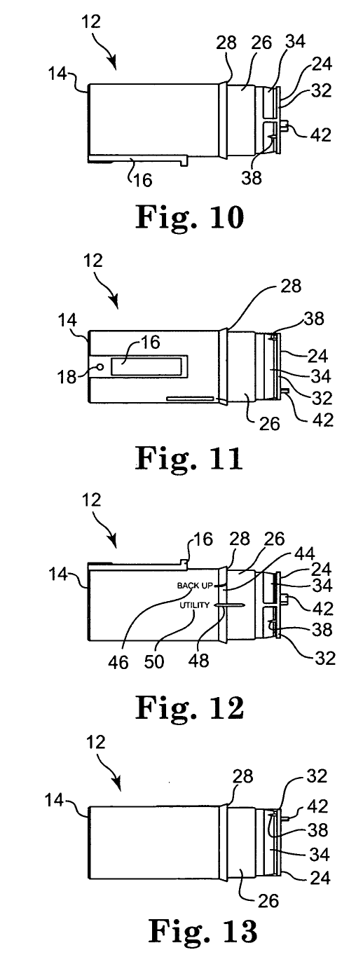

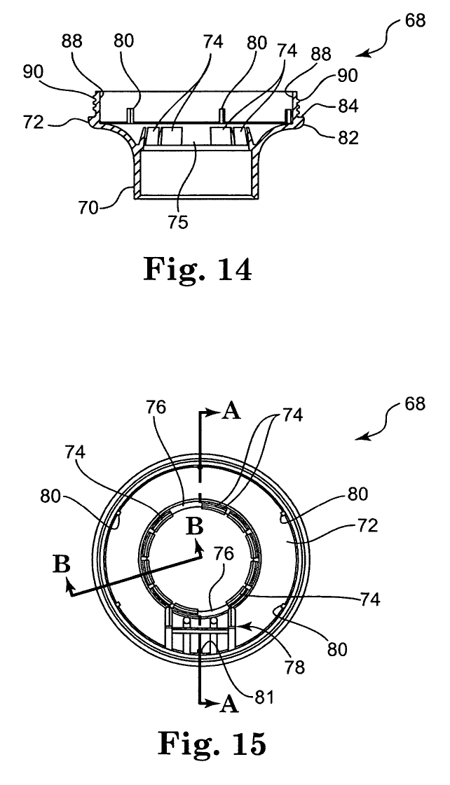

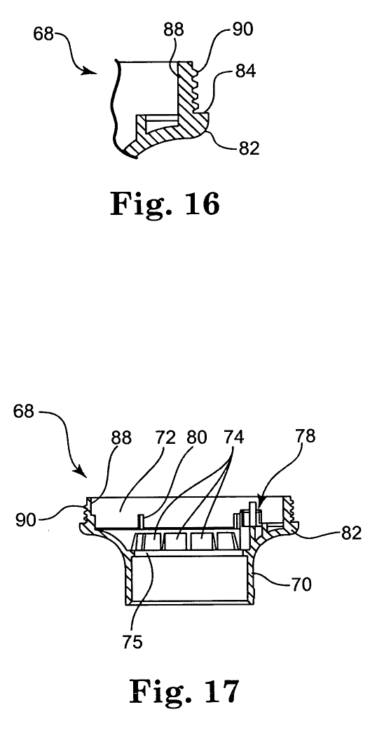

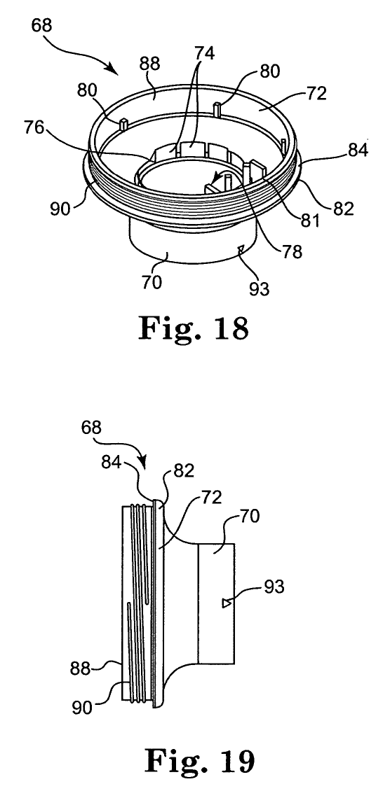

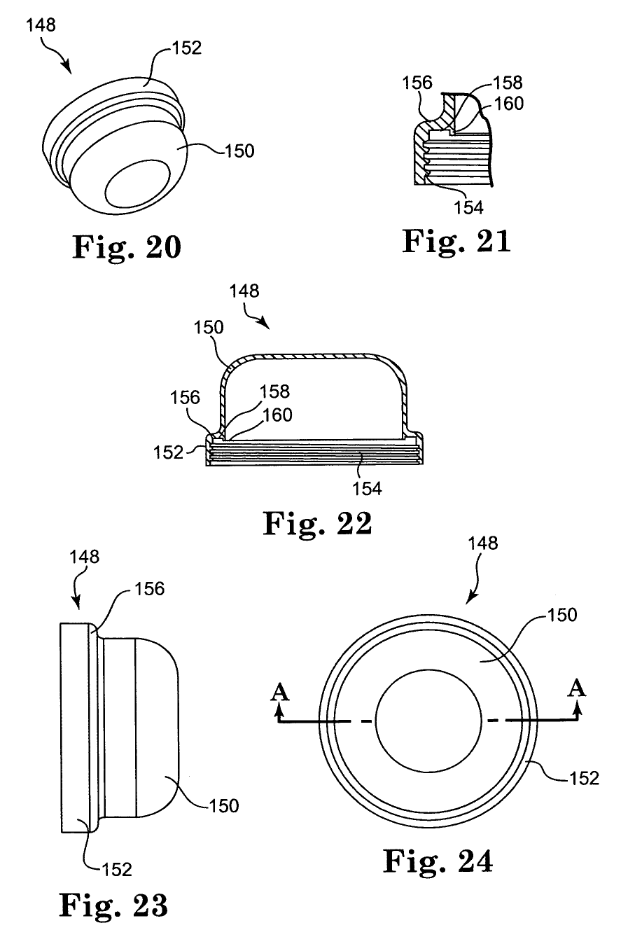

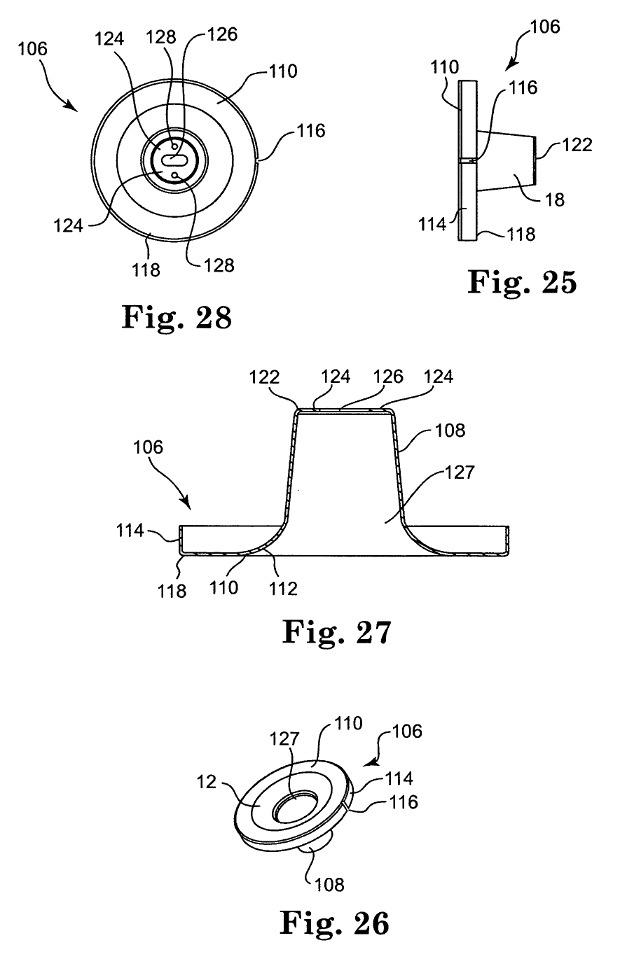

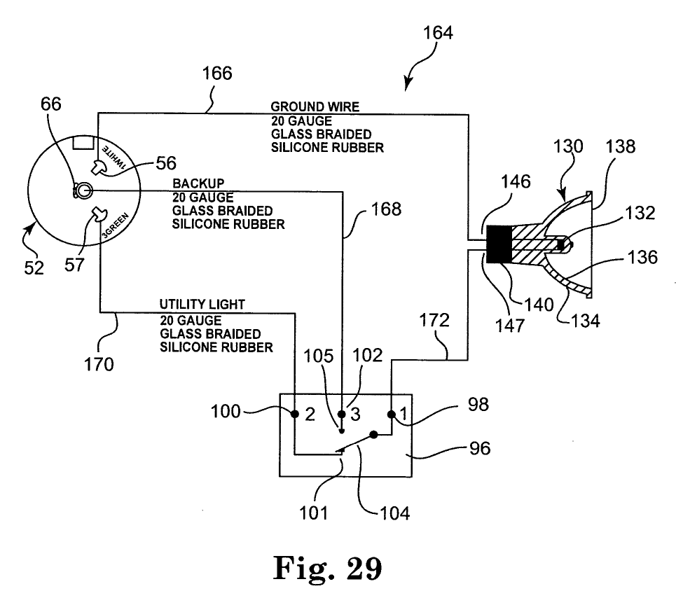

FIGS. 1 through 30 show an illustrative embodiment of a light assembly 10 incorporating principles of the present invention. The light assembly 10 includes a housing formed from at least two housing elements. The housing in the preferred embodiment shown in FIGS. 1 through 30 includes main body 12, switch body 68, and cover 148. For purposes of illustration, body 12 is generally tubular in shape. Main body 12 extends from a first end 14 to a second end 24. In this preferred embodiment, first end 14 of main body 12 is configured for direct insertion and mounting to a conventional, seven-way, round trailer electrical socket (not shown) such as is commonly found on the rear of sport utility vehicles. The seven-way, round, trailer electrical socket is usually positioned proximal to a hitch and conventionally is used to electrically couple trailer electric systems to the vehicle. The present invention, in contrast, uses this socket on the vehicle to both mount and electrically couple light assembly 10 to the vehicle.

Tubular main body 12 includes an index key 16 that helps to properly align the light assembly when inserting and mounting to a corresponding vehicle socket. The key 16 also serves as a latching point for the door (not shown) typically associated with such vehicle sockets. Such a door latches over the end of the key 16, helping to prevent the light assembly 10 from inadvertently working loose and potentially falling out.

Neck 26 generally extends from shoulder 28 to second end 24. Neck 26 is sized to mate with switch body 68. To facilitate rotatable mounting of switch body 68 to body 12, tapered sidewall 34 and rim 32 are positioned proximal to second end and define a generally annular pocket. The tapered sidewall 34, rim 32, and pocket formed by these features facilitate mounting main body 12 to switch body 68 with a snap fit engagement, described further below.

Ledge 40 is positioned at second end 24 of body 12 and supports cam 42. During relative rotation between body 12 and switch body 68, cam 42 moves through a range of motion. At one position included within this range, the cam 42 causes or allows a switch 96 to be in a first state that helps to enables a first desired lighting mode. At another position included within this range of motion, the cam 42 causes or allows the switch 96 to be in a second state that helps to enable a second desired lighting mode.

By way of example, one of these lighting modes may be a backup lighting mode. According to this mode, the light assembly 10 is coupled to the vehicle in a manner so that light assembly 10 generates a light output when the vehicle is put into reverse. As another example, an additional lighting mode may be a utility lighting mode. According to this function, the light assembly is coupled to the vehicle in a manner so that light assembly 10 generates a light output whenever the parking and/or running lights of the vehicle are turned on. As another example, an additional lighting function may be a state in which the light assembly 10 is turned off regardless of the illumination state of the vehicle to which light assembly 10 is coupled.

The body 12 conveniently is provided with features that allow the user to determine the selected mode of operation of light assembly 10. By way of example, body 12 includes back up indicator 44 and corresponding graphic indicia 46 (the alphanumeric text “Back Up”). Switch body 68 may be rotated to a position at which an indicator 93 on switch body 68 is generally aligned with the back up indicator 44. Similarly, body 12 includes utility indicator 48 and corresponding graphic indicia 50 (the alphanumeric text “Utility”). Switch body 68 may be rotated to a position at which the indicator 93 on switch body 68 is generally aligned with the utility indicator 48.

Switch body 68 rotatably mounts to main body 12 so that switch body 68 can be rotated clockwise or counterclockwise relative to main body 12. This rotation actuates switching componentry so that that the user can choose among two or more lighting modes. Switch body 68 generally includes base 70 and flared end 72. Base 70 desirably rotatably mounts to neck 26 of body 12 with a snap fit engagement. According to one approach for providing this snap fit engagement, a plurality of resilient tabs 74 project upward from throat 75 on the inside of switch body 68. Tabs 74 fit into pocket 36 with a snap-fit engagement. When switch body 68 is mounted onto neck 26, the diameter of neck 26 at rim 32 is large enough to push tabs 74 outwardly to provide the necessary clearance for rim 32 to be pushed past the tabs 74. After the rim 32 is past, the tabs 74 spring back to grip the tapered sidewall 34. Rim 32 then helps to contain the tabs 74 in position against sidewall 34, thereby securing switch body 68 on neck 26. A gasket 86 is positioned between shoulder 28 of body 12 and base 70 of switch body 68 for increased weather resistance.

The array of tabs 74 includes at least one gap 76 in which a stop 38 is positioned. The gap thereby helps to limit the range of relative rotational motion between body 12 and switch body 68. At one limit of motion, a tab 74 on one side of gap 76 prevents further rotation of stop 38. A tab 74 on the other side of gap 76 prevents further rotation of stop 38 past that other tab 74 as well.

Main body 12 and switch body 68 independently may be formed from a wide variety of materials. Examples of representative materials include metals, metal alloys, intermetallic compositions, polymers, ceramics, wood, combinations of these and the like. Examples of metals and metal alloys include weather-resistant materials such as aluminum, stainless steel, and galvanized material. Electrically insulating materials such as one or more polymers are preferred. Exemplary polymers include polyester, polyurethane, polyolefin, polyamide; polyimide, epoxy, (meth)acrylate, polystyrene, high impact polystyrene, combinations of these, and the like. Nylon, in particular, is suitable in many modes of practice.

Cover 148 is attached to switch body 68 and generally includes dome 150 and sidewall 152. Preferably, cover 148 is removable for servicing, maintenance or repair of light assembly 10. According to one mounting approach for achieving this, cover 148 is threaded onto switch body 68. To this end, sidewall 152 of cover 148 includes internal threads 154 that engage external threads 90 on sidewall 88 of switch body 68. The cover 148 helps to secure interior componentry of light assembly 10 in position when the cover 148 is mounted to switch body 68.

A gasket 94 is positioned between switch body 68 cover 148 for increased weather resistance at the juncture between these two parts. The gasket is sandwiched between shoulder 156 of cover 94 and shoulder 82 of switch body 68. Rim 160 projecting from shoulder 156 helps to hold the gasket in position.

Cover desirably is formed from one or more materials that are at least partially transparent to the light output of light assembly 10. A wide variety of translucent and/or transparent polymeric materials would be suitable. Examples of these include polyurethane, (meth)acrylate, polyester, polyolefin, polycarbonate, polyimide, polyamide, epoxy, combinations of these, and the like. In more preferred embodiments, a polycarbonate with as high a glass transition temperature as is economically feasible is used.

The assembled main body 12, switch body 68, and cover 148 house several components. Main body 12 encloses connector 52 proximal to first end 14. To facilitate accurate positioning of connector 52, index key 22 is positioned on an inside face of main body 12 proximal to first end 14. This key 22 engages a corresponding notch 64 of connector 52 and thereby helps to align and maintain the position of female connector 52 inside body 12. In desired embodiments, the connector 52 is in the form of an industry standard, female, seven-way, round electrical connector that easily plugs into the seven-way, round socket commonly used on motor vehicles such as sport utility vehicles.

Exterior face 54 of connector 52 generally includes seven terminals 56, 57, 58, 59, 60, 61, and 62. Additional connector 66 generally projects from the center of face 52. If used, these terminals 56 through 62 electrically couple light assembly 10 to corresponding terminals of the vehicle socket.

Flared end 72 of switch body 68 houses features 78 for mounting switch 96. A convenient way to mount switch 96 is by gluing switch 96 to features 78. Switch 96 is actuated to choose among two or more lighting functions. In representative modes of practice, switch 96 is in the form of an OMRON SS-Series subminiature, snap-action, type SS-5, 5AB25VAC switch, with a pin plunger actuator 104 and solder terminals 98, 100, and 102. Switch body 68 and body 12 are assembled so that cam 42 is proximal to switch 96 when switch 92 is mounted onto features 78 of switch body 68. Relative rotation between switch body 68 and body 12 in one direction causes cam 42 to actuate actuator 104, while relative rotation in the other direction causes cam 42 to or release pin plunger actuator 104. The user is able to easily select the desired lighting function by simple rotation of the switch body 68 relative to the body 12.

The switch body 68 is flared out at flared end 72 to hold secondary reflector 106. Reflector 106 includes a generally tubular neck 108 and flared end 110 having reflective surface 112. Flange 114 generally projects downward from the outer periphery 188 of flared end 110. Flange 114 helps to stiffen flared end 114. Flange 114 also helps to support reflector 106 upon posts 80 included inside flared end 72. Flange 114 includes a notch 116 that engages a key 81 on the inside of flared end 72 to facilitate proper positioning of reflector 106 in switch body 68.

The bottom end 122 of reflector 106 includes a floor provided by ledges 124. A relatively, large central aperture 126 allows wiring to be led to light socket 140. Relatively smaller apertures 128 allow light socket 140 to be mounted to ledges 124 by suitable fasteners such as screws (not shown). Light bulb socket 140 includes two terminals 146 and 147 for ground and power wiring.

Reflector 106 may be formed from a wide range of materials. Desirably, reflector 106 is made from one or more thermally conductive materials so that reflector 106 can function as a heat sink to help dissipate heat from light bulb assembly 130. In particular, the relatively long hollow neck 108 can help to pull heat away from light bulb assembly 130. In typical embodiments, fabricating reflector from a metal, metal alloy, intermetallic composition, combinations of these, and the like, would be suitable. In one embodiment, 1008/1010 cold roll steel with decorative chrome plating is suitable.

Light bulb assembly 130 plugs into socket 140 and desirably may be removed for replacement, maintenance, or service. Optional support structure (not shown) at the throat 127 of reflector 106 may be used to help to support light bulb assembly 130 if desired. Light emitting element 132 is housed within an enclosure defined at least in part by reflector 134 and cover 138. In preferred embodiments, the surface of reflector 106 is heat reflecting to help dissipate heat generated by light emitting element 132. Aluminum is one example of a heat reflecting surface.

As another preferred feature, reflector 134 desirably is dichroic. Dichroic means that the reflector 134 reflects a portion of the light output of light emitting element 132 while another portion of the light output incident upon reflector 104 passes through reflector 134. The light passing through will tend to be reflected to a large degree by reflector 106. In this manner, the preferred embodiment of light assembly 10 uses two stages of reflection to illuminate the surroundings. This is advantageous, because the use of more than one stage of reflection helps to produce a broad, uniform field of illumination.

Specific examples of commercially available products suitable for use as light assembly 130 include the halogen lights commercially available from Koninklijke Philips Electronics N.V. under the trade designations MR16 and MR11. These commercially available lights include halogen light emitting elements housed inside a chamber defined by a dichroic and heat reflecting reflector and a light transmissive cover. Philips lighting products operating at 12 volts and 50 Watts are preferred.

Optionally, one or more retainer clips (not shown) may be used to help light bulb assembly 130 in socket 140. For instance, one end of such a clip may be attached to the reflector 106 while the other end of such a clip reaches over cover 138.

The wiring system 164 used in light assembly 10 is seen best in FIG. and helps to configure light assembly 10 so that a user can easily select a mode of operation from among two or more of such modes. For purposes of illustration, wiring system 164 is configured to allow the user to select between a reverse/back-up lighting mode and a utility mode. The common ground wire 166 runs from terminal 56 on female connector 52 to the grounding terminal 146 of light bulb socket 140. The metal reflector and the metal frame of the light bulb assembly 130 may complete the grounding circuit. A second wire 168, for reverse/back-up mode, runs from central terminal 66 on female connector 52 to terminal 102 of switch 96. This circuit may be completed by a wire 172 running from terminal 98 of switch 96 to terminal 147 on light bulb socket 140. Another wire 170 runs from terminal 57 of female connector 52 to terminal 100 of switch 96. This circuit also may be completed by wire 172. The wiring preferably is glass-coated for heat resistance.

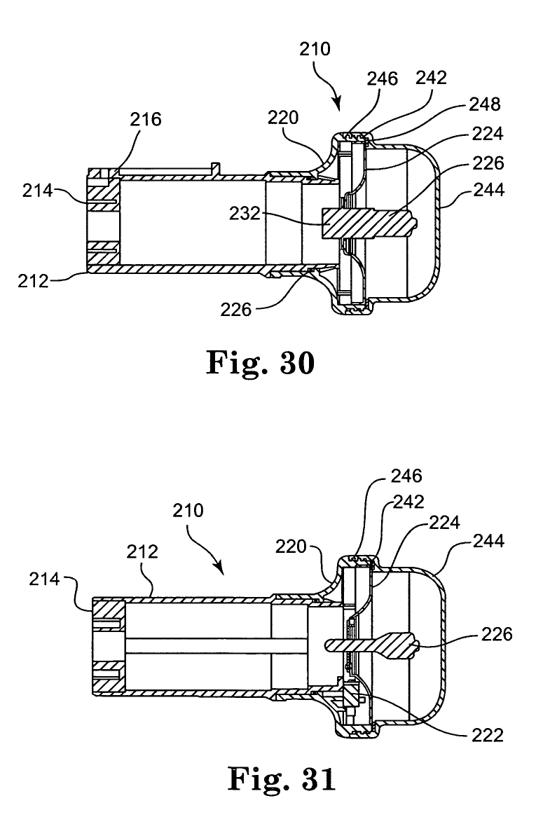

In use, a back up/reverse mode or a utility mode may be selected by rotating switch body 68 relative to main body 12 to the desired setting. When switch body 68 is positioned so that cam 42 depresses actuator 104 on switch 96, the actuator 104 contacts terminal 105 associated with terminal 102 (this position of actuator 104 is not shown in FIG. 30). The light assembly 10 is in a back-up/reverse mode and will generate a light output whenever the vehicle is put into reverse. When switch body 68 is positioned so that the cam 42 releases the actuator 104, the actuator 104 contacts terminal 101 associated with terminal 100 (this position of actuator 104 is shown in FIG. 30.). The light assembly 10 is in a utility mode and will generate a light output whenever the parking or running lights of the vehicle are turned on.

An alternative embodiment of a light assembly 210 is shown in FIGS. 31 and 32. Light assembly 210 is similar to light assembly 10, except that light assembly 210 has a different reflector and light bulb assembly configuration. In more detail, the light assembly 210 includes a tubular main body 212 that encloses at one end a female seven way round electrical connector 214. The main body has an index key 216 which properly aligns the plug and its terminals by way of a matching keyway in a conventional, seven-way, round trailer electrical socket (not shown) located on a vehicle. The index key 216 also serves as a latching point for the door (not shown) of the seven way round trailer electrical socket on the vehicle. The door latches over the end of the key 216, helping to prevent the light assembly 210 from working loose and potentially falling out.

At the other end of the main body 212 is the switch body 220. The switch body 220 houses a switch 222, reflector 224, and light bulb 226. The switch body 220 snaps onto the main body 212 in a manner that allows for relative rotation between the switch body 220 and the main body 212. The switch body 220 is designed to rotate clockwise or counter clock. This provides the user of the light a choice between using the light in reverse mode or in utility mode. A gasket 226 is located between main body 212 and switch body 220 for increased weather resistance.

The switch body 220 is flared out to hold chromed metal reflector 224. The reflector 334 is shaped to hold, for example, a replaceable H3 style Halogen bulb 226. The bulb housing is held in place by a socket 232 mounted in the reflector 230.

Attached to the main body 212, but enclosed within the switch body 220, is a snap action subminiature switch 222. A cam (not shown) located on the switch body 220 activates the switch 222, allowing the user to choose either the reverse/backup mode (when the vehicle is put in reverse) or the utility mode (when the parking or running lights of the vehicle are turned on). Stops located on the switch body 220 prevent the switch body 220 from rotating too far clockwise or counterclockwise relative to main body 212.

The switch body 220 has external threads 242. A lens cover 244, made from a suitable light transmissive material such as a polycarbonate and provided with internal threads 246, is screwed onto the switch body 220. A rubber lens gasket 248 is located between the lens cover 244 and the reflector 224, providing a weather resistant seal. When the lens cover 244 is screwed into place, the reflector 224 and bulb 226 are held in place.

Wiring is run inside the body of the light assembly 210 in a manner similar to the wiring used in light assembly 10 described above. Thus, the light assembly 10 has multiple modes that are easily selected by rotating switch body 220 relative to main body 212 to the desired setting. In a reverse/back up mode, the cam moves to a position so that the switch 222 is in a state that allows the light bulb 226 to illuminate whenever the vehicle is placed into a reverse gear. In a utility mode, the cam moves to a position so that switch 222 is in a configuration that allows light bulb 226 to illuminate when the vehicle parking and/or running lights are turned on.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A light assembly for a vehicle, comprising:
a housing comprising at least first and second housing elements, wherein the first housing element is rotatable with respect to the second housing element;
a light emitting element positioned in the housing, said light emitting element emitting a first light output in accordance with a first mode of operation and a second light output in accordance with a second mode of operation; and
a switch incorporated into the light assembly in a manner such that relative rotation of the first and second housing elements allows a user to select a mode of operation from the group including at least the first and second modes of operation.

2. The light assembly of claim 1, wherein the first housing element comprises a connector that allows the light assembly to be both mounted to and electrically coupled to a socket on the vehicle in a manner that allows a user to select a mode of operation from among a group including at least first and second modes of operation, wherein said selecting causes the light emitting element to generate a light output depending upon a state of the vehicle.

3. The light assembly of claim 2, wherein the relative rotation of the first and second housing elements causes the light assembly to change from one mode of operation to another mode of operation.

4. The light assembly of claim 2, wherein the connector is a seven-way, round, trailer electrical socket.

5. The light assembly of claim 1, further comprising a cam associated with the first housing element and a switch associated with the second housing element, wherein relative rotation of the first and second housing elements causes movement of the cam to actuate the switch.

6. The light assembly of claim 5, wherein the switch is internally housed inside the light assembly.

7. The light assembly of claim 2, wherein the first mode of operation is one in which the light assembly generates a light output when a vehicle to which the light assembly is coupled is in a reverse gear and wherein the second mode of operation is one in which the light assembly generates a light output when a parking light of the vehicle is turned on.

8. The light assembly of claim 1, further comprising a dichroic surface in optically reflecting communication with a light emitting source housed in the light assembly.

9. The light assembly of claim 8, further comprising a secondary reflector.

10. The light assembly of claim 1, further comprising a light emitting source housed in the light assembly and a passive heat sink thermally coupled to the light emitting source.

11. The light assembly of claim 10, wherein the passive heat sink is an elongated neck of a reflector, said reflector being in optically reflective communication with the light emitting source.

12. The light assembly of claim 10, further comprising a reflector having a surface comprising aluminum.

13. The light assembly of claim 1, further comprising an encased light bulb.

14. A light assembly for a vehicle, comprising:
a housing;
a light emitting element positioned in the housing; and
wherein the light assembly is both mounted to and electrically coupled to a socket on the vehicle in a manner that allows a user to select a mode of operation from among a group including at least first and second modes of operation, wherein said selecting causes the light emitting element to generate a light output depending upon a state of the vehicle.

15. A light assembly for a vehicle, comprising:
a light emitting element that is electrically coupled to the vehicle in a manner such that the light emitting element generates a light output in accordance with a mode of operation that depends upon a state of the vehicle; and
a dichroic surface positioned in a manner effective to reflect a portion of the light output and is light transmissive with respect to a second portion of the light output.

16. A light assembly for a vehicle, comprising:
a light emitting element that is electrically coupled to the vehicle in a manner such that the light emitting element generates a light output in accordance with a mode of operation that depends upon a state of the vehicle;
a dichroic surface positioned in a manner effective to reflect a portion of the light output and is light transmissive with respect to a second portion of the light output; and
a secondary reflecting surface positioned in a manner effective to reflect a portion of the light transmitted through the dichroic surface.

17. A light assembly for a vehicle, comprising:
a light emitting element that is electrically coupled to the vehicle in a manner such that the light emitting element generates a heat output and further generates a light output in accordance with a mode of operation that depends upon a state of the vehicle; and
a reflector comprising a reflecting surface that reflects at least a portion of the light output outward to provide illumination and an elongated neck, wherein the elongated neck is in thermal contact with the light emitting element in a manner such that the elongated neck functions as a heat sink to help dissipate at least a portion of the heat output.

18. A light assembly for a vehicle, comprising:
a light emitting element that is electrically coupled to the vehicle in a manner such that the light emitting element generates a heat output and further generates a light output in accordance with a mode of operation that depends upon a state of the vehicle; and
an encasement having an interior in which the light emitting element is positioned, said encasement comprising
a light and heat reflecting surface positioned in a manner effective to reflect at least a portion of the light and heat output and
a light transmissive cover through which the light output and the reflected light pass to illuminate an area in the proximity of the light assembly.

19. A light assembly for a vehicle, comprising:
a light emitting element that is electrically coupled to the vehicle in a manner such that the light emitting element generates a heat output and further generates a light output in accordance with a mode of operation that depends upon a state of the vehicle; and
an encasement having an interior in which the light emitting element is positioned, said encasement comprising a light and heat reflecting surface positioned in a manner effective to reflect at least a portion of the light and heat output and a light transmissive cover through which the light output and the reflected light pass to illuminate an area in the proximity of the light assembly.
